(19) United States
(12) Patent Application Publication
(10) Pub. No.: US 2014/0084755 A1
(43) Pub. Date: Mar. 27, 2014

(54) ON-VEHICLE ROTARY ELECTRIC MACHINE

(71) Applicant: Hitachi Automotive System, Ltd., Hitachinaka-shi (JP)

(72) Inventors: Yasunaga HAMADA, Hitachinaka (JP); Kenji NAKAYAMA, Hitachi (JP); Shozo KAWASAKI, Hitachinaka (JP); Hiroshi KANAZAWA, Tokyo (JP)

(73) Assignee: Hitachi Automotive System, Ltd., Hitachinaka-shi (JP)

(21) Appl. No.: 13/971,263

(22) Filed: Aug. 20, 2013

(30) Foreign Application Priority Data
Sep. 27, 2012 (JP) 2012-213390

(51) Int. Cl. H02K 5/15

(52) U.S. Cl. CPC H02K 5/15
USPC 310/432

(57) ABSTRACT

An on-vehicle rotary electric machine includes a first member provided with a stator, a rotor, and a housing in which the stator and the rotor is housed, a second member adjacent to the first member in an axial direction, and a third member adjacent to the second member in the axial direction at an opposite side of the first member, and the first member, the second member, and the third member are pierced by a through bolt in the axial direction and are fixed.

### BACKGROUND OF THE INVENTION

1. Field of the Invention

The present invention relates to an on-vehicle rotary electric machine, and particularly relates to a mounting structure of an on-vehicle rotary electric machine capable of suppressing a vibration and reducing a noise.

2. Description of the Related Art

Following two documents can be given as a conventional technology. JP-2008-290614-A discloses a structure in which a reduction gear box in an electric power steering apparatus is equipped with an electric motor and a control unit, a drive motor (first member), an inverter unit (second member), and a control connector unit (third member) are placed next to each other in this order in an axial direction, and the electric motor and the reduction gear box are coupled together with a through bolt.

Also, JP-2011-079495-A discloses that a motor housing and an ECU casing of an electric power steering apparatus are fastened with a bolt. It is structured such that a cylindrical elastic supporting member is inserted into a bolt hole of the motor housing, and transference of a vibration of a motor to an ECU is suppressed.

### SUMMARY OF THE INVENTION

The apparatus disclosed in JP-2008-290614-A has the drive motor (first member), the inverter unit (second member), and the control connector unit (third member) of the electric power steering apparatus placed next to each other. However, since the members are mutually fastened, the number of fastening bolts is large and fastening directions vary. Therefore, there are problems such that considerable assembly processes are required and it is not an inexpensive structure.

Also, the apparatus disclosed in JP-2011-079495-A has the motor housing and the ECU casing of the electric power steering apparatus fastened with a bolt, the cylindrical elastic supporting member is inserted into the bolt hole of the motor housing, and transference of a vibration of the motor to the ECU is suppressed. With this structure, the elastic supporting member needs to be prepared as a separate member. Therefore, it cannot be an inexpensive structure, and no consideration is given to reduction of the vibration itself.

To solve the above problems, it is configured such that a drive motor (first member), an inverter unit (second member), and a control connector unit (third member) are coaxially arranged, and the whole members are fixed to a driven part all together with a through bolt. With such a configuration, the number of mounting bolts is reduced, and the fixing directions face in the same direction. Therefore, the assembly processes can be reduced, and an inexpensive structure can be provided. Further, the structure of coaxially layering the first member, the second member, and the third member in a three-tiered manner is a cantilever structure in which the three members are held to a non-driving part. Therefore, there is a concern, in the event of a vibration, that a vibration mode may occur in which an electric connection connector side at an end portion side based on the non-driving part is whirled. However, the whirling vibration can be suppressed and a noise can be also suppressed by using the through bolt.

Further, as to a concern of generation of a noise due to resonance of a long through bolt, a configuration is employed such that an elastic member is laid among near the center of the through bolt, an electric motor, and a fitting flange of a driver unit, so that the concern can be resolved.

According to the present invention, an on-vehicle rotary electric machine having less assembly processes and generating less vibration can be provided.

### BRIEF DESCRIPTION OF THE DRAWINGS

FIG. 1 is a structure illustration of an on-vehicle rotary electric machine according to an embodiment of the present invention;

FIG. 2 is an illustration of an example of a fixed state of a through bolt according to the embodiment of the present invention;

FIG. 3 is a structure illustration of the on-vehicle rotary electric machine according to the embodiment of the present invention;

FIG. 4 is a structural diagram of an example where an elastic member is fixed to a bolt according to the embodiment of the present invention; and

FIG. 5 is a structural diagram of an example where the elastic member is inserted into a flange portion in advance according to the embodiment of the present invention.

### DESCRIPTION OF THE PREFERRED EMBODIMENTS

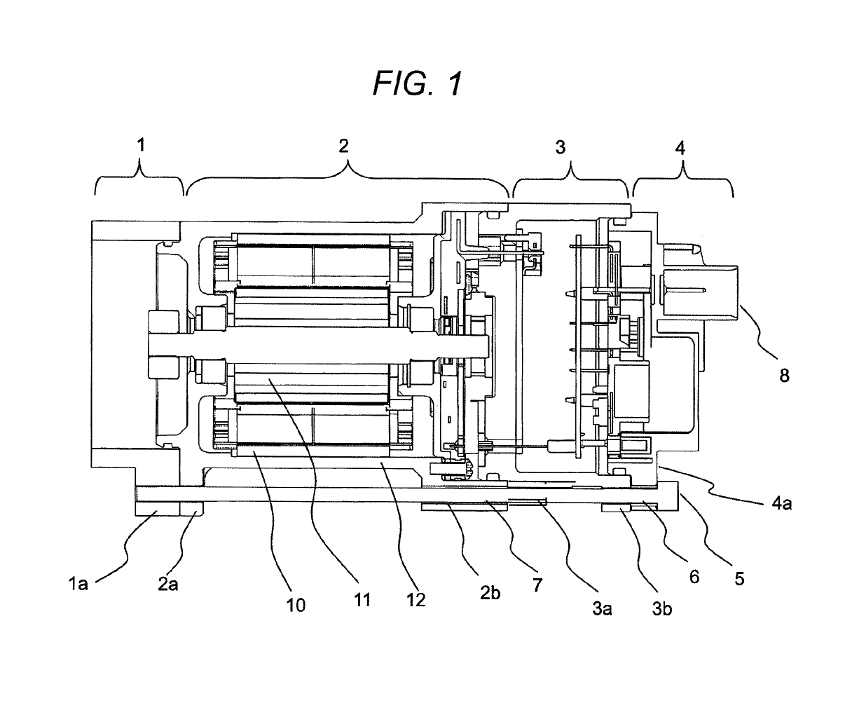

An embodiment according to the present invention is illustrated in FIG. 1.

As an on-vehicle rotary electric machine, a drive motor unit 2, an inverter unit 3, and a control unit connector 4 are layered in this order with respect to a driven part case 1, and are fixed to a screw-worked mounting flange la of a driven part case with three through bolts 5, for example, through a control unit mounting flange 4a, an inverter unit mounting flange (inverter side) 3b, an inverter unit mounting flange (drive motor side) 3a, a drive motor unit mounting flange (inverter side) 2b, and a drive motor unit mounting flange (driven side) 2a, so that the on-vehicle rotary electric machine functions in a mechanically and electrically integrated manner.

When electric power is supplied to a connector part 8, the electric power is controlled by the control unit 4 coupled to the connector part 8, and is transferred to the inverter unit 3. The electric power is converted into AC power by the inverter unit 3, and is supplied to the drive motor unit 2. A revolving magnetic field occurs in a stator 10 housed in a housing 12, so that a rotor 11 is rotated to transfer power to a driven side via a gear and the like.

The control unit 4 including the connector part 8 is formed of a resin case for the purpose of electric insulation. The resin case cannot bear a tightening load of the through bolts 5 in a direct way. Therefore, it is configured such that a mounting bush 6 is formed by insert molding, and the mounting bush 6 is subjected to the tightening load.

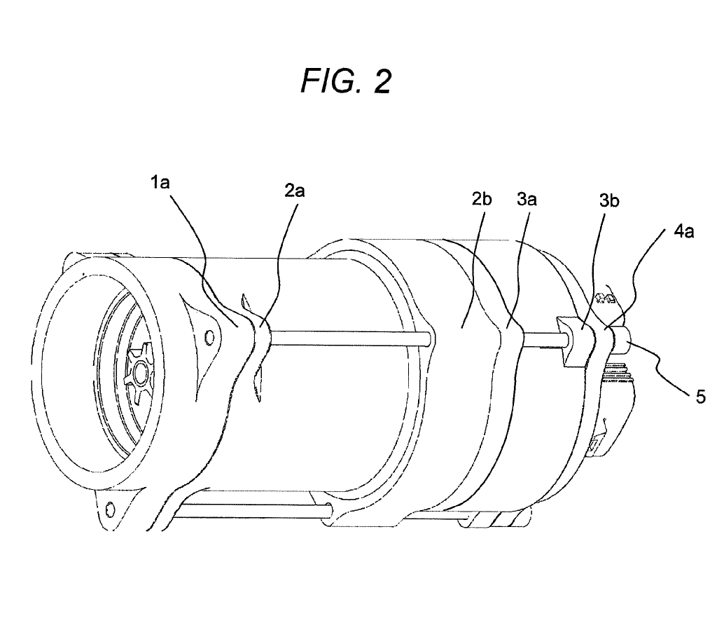

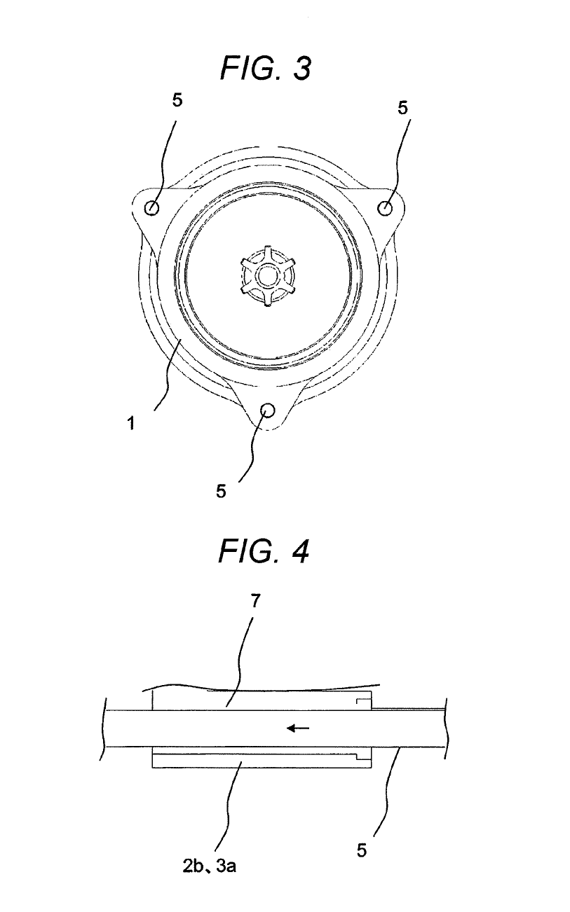

That is, the three through bolts 5 generate tension with the mounting bush 6 located furthest from the driven part case flange 1a, and are fixed while keeping balance roughly at regular intervals in a circumferential direction. This form is illustrated in FIGS. 2 and 3. Thus, even the cantilever structure supports a vicinity of the end portion of the whirling. Therefore, a vibration as external force or a vibration due to rotation of the rotor 11 can be suppressed.

Here, the number of the through bolts 5 requires two or more in terms of balancing. Also, the bolt may be a stud bolt, and is fixed with a nut.

To realize the mechanically and electrically integrated structure, the long through bolts 5 are used for fixing. Therefore, there is a concern that the bolts themselves are vibrated and may cause a noise. Therefore, it is configured such that an elastic member 7 such as rubber is disposed between an internal diameter portion of the flanges located near the center of the length of the through bolts 5 ((the drive motor unit mounting flange (inverter side) 2b and the inverter unit mounting flange (drive motor side) 3a)) and the through bolts 5, so that the vibration of stem portions of the bolts is suppressed. A state is illustrated in FIG. 4, where a step is provided in this flange portion so that the through bolts 5 cannot be come out at the time of insertion and the elastic member 7 is disposed in this flange portion in advance.

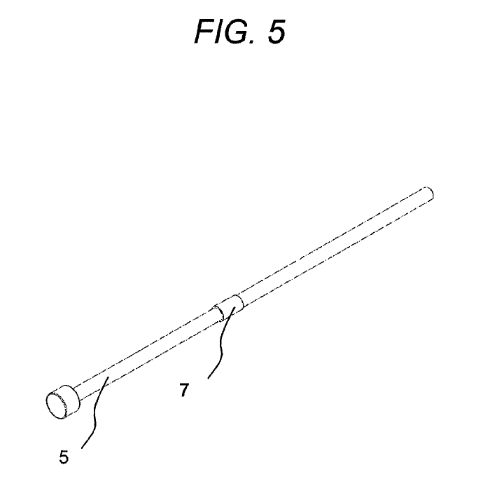

Also, an example in which the elastic member 7 is applied to the through bolt 5 in advance is illustrated in FIG. 5. This elastic member may be substituted for an adhesive and the like. Further, the disposing of the elastic member 7 has a function to lock the through bolt 5.

With such a configuration, the drive motor unit 2, the inverter unit 3, and the control unit connector 4 are layered in this order with respect to the driven part case 1 to form a mechanically and electrically integrated structure, so that an electrically loss-less configuration is secured. Such a structure is fixed with the three through bolts 5, whereby the number of mounting bolts can be reduced, and an inexpensive structure with reduced assembly processes can be realized. Also, since the end portion direction that is whirled is supported, a vibration can be suppressed. Further, the elastic supporting member is provided between the central portion of the through bolts and the flange portion where the bolts pierce, whereby the vibration of the long through bolts 5 can be suppressed, and the possibility of generation of a noise can be suppressed.

Functions and effects of the above-described embodiment according to the present invention are as follows.

A drive motor (first member), an inverter unit (second member), and a control connector unit (third member) are coaxially arranged and have a mechanically and electrically integrated structure, and electrical connection is housed in each cabinet, whereby special electric wiring and the like is not required outside the cabinet, and an effective structure and arrangement having no loss like an increase of resistance and the like can be realized.

To realize this structure, it is configured such that the whole members are fixed to a non-driving part all together with through bolts. Therefore, the number of mounting bolts is reduced, and the fixing directions face in the same direction, whereby the assembly processes can be reduced and an inexpensive structure can be provided. Further, the structure in which the (first member), the (second member), and the (third member) are coaxially layered in a three-tiered manner is a cantilever structure wherein the members are held with respect to a non-driving part. Therefore, there is a concern, in the event of a vibration, that a vibration mode may occur in which an electric connection connector side at an end portion side based on the non-driving part is whirled. However, use of the through bolts suppresses the whirling vibration as well as a noise.

Furthermore, as to the concern of generation of a noise due to resonance of the long through bolts, it is configured such that the elastic member is laid among near the center of the through bolts, the electric motor, and the fitting flanges of the driver unit. Therefore, there is an effect of resolving this concern.

What is claimed is:

1. An on-vehicle rotary electric machine comprising:
a first member including a stator, a rotor, and a housing in which the stator and the rotor is housed;
a second member adjacent to the first member in an axial direction; and
a third member adjacent to the second member in the axial direction at an opposite side of the first member, wherein
the first member, the second member, and the third member are pierced by a through bolt in the axial direction and are fixed.

2. The on-vehicle rotary electric machine according to claim 1, wherein, with respect to the first member or the second member, or both of the first member and the second member, a flange peripheral part where the through bolt pierces or is adjacent is provided with an elastic member.

3. The on-vehicle rotary electric machine according to claim 1, wherein the through bolt is provided with an elastic member.

4. An on-vehicle rotary electric machine including a stator, a rotor, and a housing in which the stator and the rotor is housed, having a structure in which members are layered in an axial direction and are fastened with a through bolt, and an elastic member is provided between a flange portion of a member to which the through bolt is adjacent and a bolt portion within a range subjected to axial force.
